(19) United States
(12) Patent Application Publication
(10) Pub. No.: US 2012/0255941 A1
(43) Pub. Date: Oct. 11, 2012

(54) Heated stuffed animal clothes warmer

(76) Inventor: James E. Skarzynski, West Sand Lake, NY (US)

(21) Appl. No.: 13/066,239

(22) Filed: Apr. 11, 2011

(51) Int. Cl. H05B 1/00

(52) U.S. Cl. 219/201

(57) ABSTRACT

A stuffed animal with an inside pouch that is heated. This heated pouch is accessed via an opening located at the top side of the stuffed animal back and secured by a zipper, Velcro or other fastening device. The exterior of the stuffed animal is made of a soft body material. The pouch is heated with an electric heating device/pad that surrounds the inner cavity of the animal. There is an electric AC cord that connects to the heating device from the side of the stuffed animal. The electric cord can be removed by depressing clips where the cord connects to the stuffed animal. The cord has a temperature control for various heating settings. The heating device also will have an automatic shut-off feature.

### 1. FIELD OF THE INVENTION

This invention of a heated stuffed animal clothes warmer, and particularly to a stuffed animal containing a heating warming element/pad, surrounding an internal pouch, used to heat clothes and other garments.

### 2. DESCRIPTION OF RELATED ART

There are variety of heated stuffed animals that are know in the art; U.S. Pat. No. 1,558,278, U.S. Pat. No. 5,002,511, U.S. Pat. No. 1,896,663, U.S. Pat. No. 4,954,676, U.S. Pat. No. 2,647,196, U.S. Pat. No. 4,714,445, U.S. Pat. No. 2,859,731, U.S. Pat. No. 7,241,196, U.S. Pat. No. 4,204,110, U.S. Pat. No. 6,325,695, U.S. Pat. No. 6,488,561, which relate to therapeutic uses, and a variety of heated clothes warmers; Pub. No. US 2009/0032516 application Ser. No. 12/220,962 Warming Bag, Pajama Warmer, U.S. Pat. No. 7,723,646 B2 Foldable Clothes Warmer.

None of the prior art heated stuffed animals and/or clothes warmers, however, disclose or suggest the combination of features of a heated stuffed animal clothes warmer of the present invention, as is described herein below.

### SUMMARY OF THE INVENTION

The object of this invention is to provide an electric heated stuffed animal clothes warmer that can be used to warm up various garments, such as; pajamas, gloves, scarfs, baby blankets, or any other garment need to be warmed up, by putting them in the heated animal pouch. This will provide a warm cuddly garment that will be warm and southing to the touch. The user is envisioned to be an adult or child under adult supervision, having the need to warm up articles of clothing or other garments.

The heated stuffed animal clothes warmer of the present invention has the following combination of features which is not suggested in any prior patents. The heated stuffed animal clothes warmer is comprised of soft exterior body having an inner pouch accessed via a zipper on the upper portion. The outer covering has the appearance of various living and non-living creatures. The interior is surrounded by a heating pad/device that is used to warm up garments. The heating pad/device has an exterior detachable AC power cord that detaches at close proximity to the animal. This exterior detachable AC power cord also has a temperature control switch that automatically shuts off after a specific predetermined temperature is reached. These and other features of the invention are described herein below in further detail.

### BRIEF DESCRIPTION OF DRAWINGS

FIG. 1 is a top view of the heated stuffed animal clothes warmer which illustrates the fastening device for the pouch, the access pouch, the heating device which lines the inner pouch, and the location of the AC electrical cord.

FIG. 2A is a top view illustration of the AC electrical cord end that connects and disconnects from the heated stuffed animal clothes warmer. In this figure it is denoted as Detachable AC Power Cord.

FIG. 2B is a top view illustration of the AC electrical cord end that connects to the electrical socket. This figure also illustrates the Adjustable Thermostat Temp. Control device.

### DETAILED DESCRIPTION OF THE PREFERRED EMBODIMENT(S)

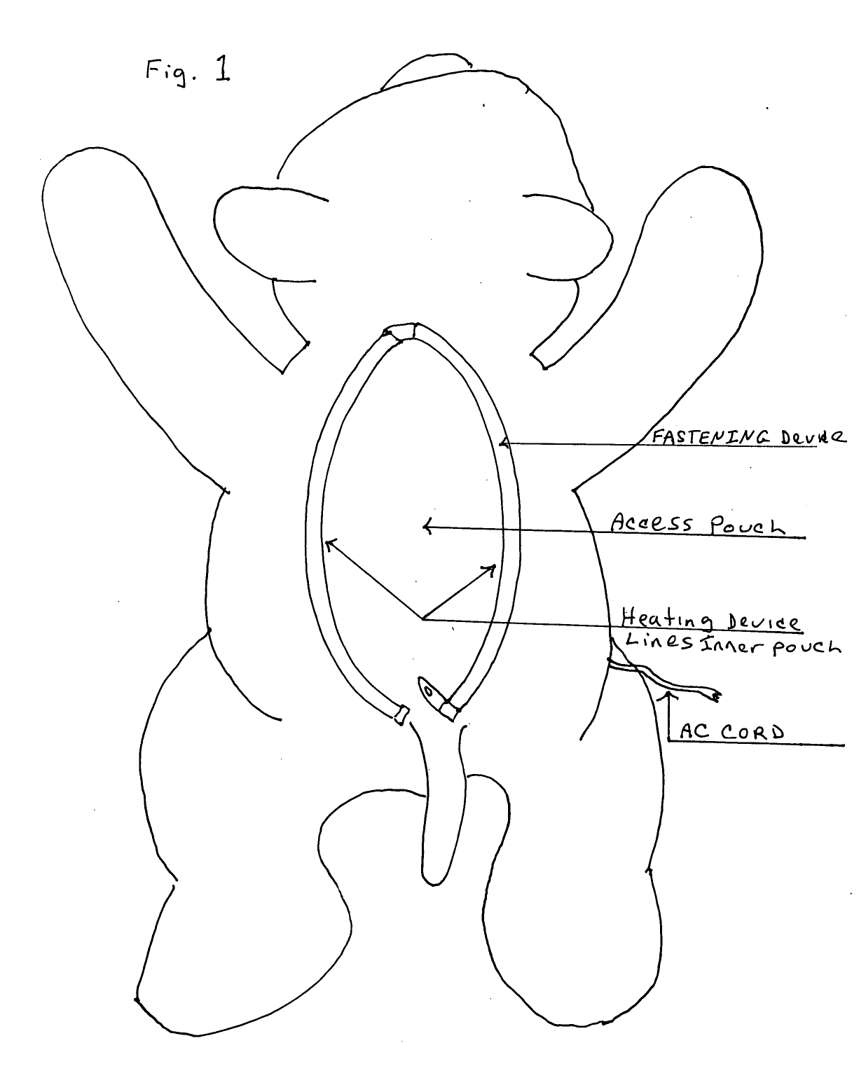

The heated stuffed animal clothes warmer is comprised of a soft exterior body which is made from synthetic and/or natural materials. The outer design will take the shape of the animal/creature it represents, as shown in FIG. 1. The exterior of the body will have an access point on the upper portion of the stuffed animal that will allow access to a pouch that is housed within, as shown in FIG. 1. This pouch is accessed via a zipper, Velcro, or any other fastening device which will allow entry, as shown in FIG. 1.

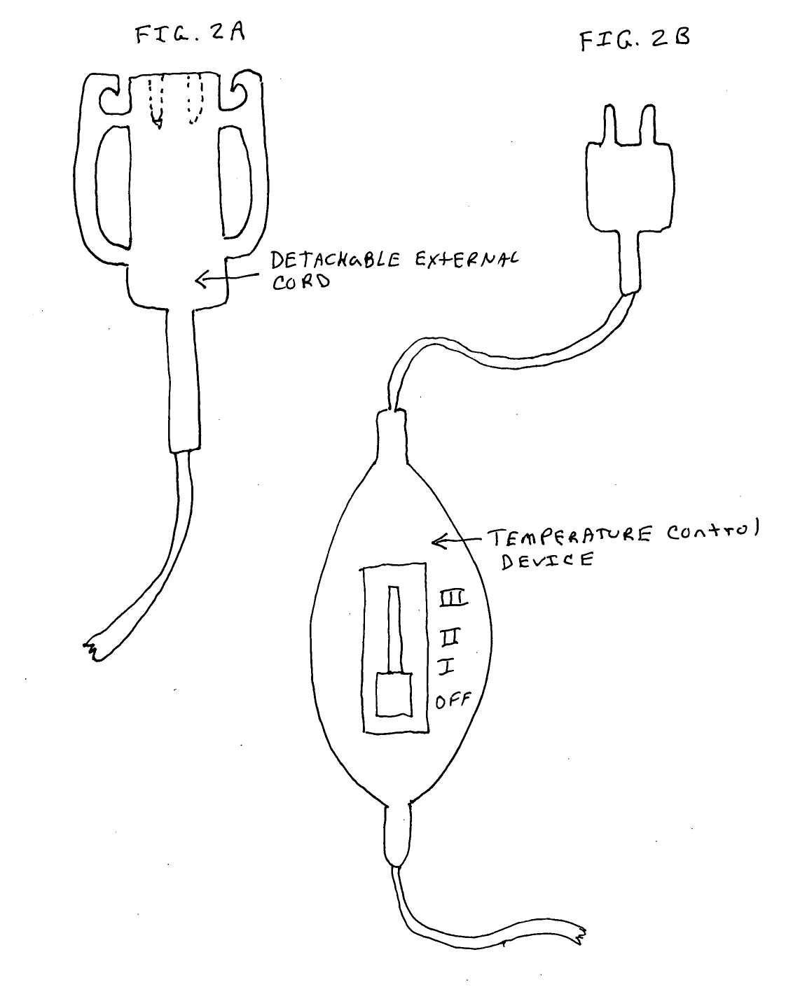

The inner cavity is lined with a heating pad/device that will be in close proximity to the clothing and/or garments that are put inside the pouch to be warmed, as shown in FIG. 1. This heating pad/device is incorporated within the stuffed animal and is not intended to be removed. The heating pad/device will allow the clothes and/or garments to reach a desired temperature. There will be an external AC power cord, as shown in FIG. 2, that can be removed at close proximity to the stuffed animal via a detachable end, as shown in FIG. 2. This will allow the animal to be cuddled, after the clothes and/or garments are removed, while still warm while not having the electrical cord attached. The AC power cord will have a temperature control, or other control device, and will be equipped with an automatic shutoff provision, as shown in FIG. 2. The temperature control will have various settings depending on the desired warmth.

It is envisioned that the user will be an adult, teenager, or child under adult supervision and the heated stuffed animal will be used to warm pajamas before bed, warm outdoor garments such as gloves, hat and scarf before going outdoors, warming baby blankets or warming any desired articles of clothing.

The heated stuffed animal clothes warmer's inner stuffing will be made of a fire resistant material.

There may be modifications to the heated stuffed animal clothes warmer invention, but will not depart from the scope and spirit of the invention. Thus, any modification will be within the scope of the invention.

1. Heated stuffed animal clothes warmer comprising:
A soft exterior body depicting some type of living creature.
A pouch that is accessed via the top portion of the stuffed animal. The pouch is accessed by a fastening device i.e. zipper, Velcro,
An electric heating device that surrounds the interior portion of the stuffed animal to heat the contents that is put in the stuffed animal, said electric heating element/pad has an electric cord that connects and disconnects from the side of the stuffed animal. Cord is used to connect to an external AC power supply,
Means for selecting various heat settings is attached to the heating element cord.

2. The heated stuffed animal clothes warmer according to claim 1, wherein said outer covering will have the appearance of a live creature, i.e. cat, turtle, bear etc.

3. The heated stuffed animal clothes warmer according to claim 1, wherein said inner cavity will be comprised of a flame resistance stuffing material.

4. The heated stuffed animal clothes warmer according to claim 1, wherein said inner cavity will be comprised of a heating element\pad which surrounds the inner walls of the pouch.

5. The heated stuffed animal clothes warmer according to claim 1, wherein said inner heated pouch will have the capacity to warm various clothing articles.

6. The heated stuffed animal clothes warmer according to claim 1, wherein said electric AC heating element\pad cord will included a thermostat temperature control for various heating settings.

7. The heated stuffed animal clothes warmer according to claim 1, wherein said electric AC heating element\pad included an automatic shut-off feature.

8. The heated stuffed animal clothes warmer according to claim 1, wherein said heating element\pad electric AC cord will detach from the heated stuffed animal at close proximity to the animal.

9. The heated stuffed animal clothes warmer according to claim 1, wherein said outer covering will be comprised of a soft synthetic or natural flame retardant material.

10. The heated stuffed animal clothes warmer according to claim 1, wherein said outer cover will have an opening to access the inner cavity.

11. The heated stuffed animal clothes warmer according to claim 9, wherein said outer cover has a fastening device, i.e. zipper, Velcro, that will be located on the top side of the stuffed animal to access the inner pouch of the stuffed animal.
